(19) United States
(12) Patent Application Publication
(10) Pub. No.: US 2004/0032651 A1
(43) Pub. Date: Feb. 19, 2004

(54) Method for scanning microscopy, and scanning microscope

(75) Inventors: Rafael Storz, Heidelberg (DE); Holger Birk, Meckesheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/617,841

(22) Filed: Jul. 11, 2003

(30) Foreign Application Priority Data
Jul. 13, 2002 (DE) DE 102 31 776.3

(51) Int. Cl. G02B 21/06

(52) U.S. Cl. 359/385

(57) ABSTRACT

In a method for scanning microscopy a specimen, that contains at least one fluorescent dye, is illuminated with illuminating light. The detection light proceeding from scan points of the specimen is detected with a spectral detector that generates spectral data for each scan point. An amplitude value is determined from the spectral data for each fluorescent dye and transferred to a processing module.

### CROSS REFERENCE TO RELATED APPLICATIONS

This application claims priority of the German patent application 102 31 776.3 which is incorporated by reference herein.

### FIELD OF THE INVENTION

The invention concerns a method for scanning microscopy. The invention further concerns a scanning microscope.

### BACKGROUND OF THE INVENTION

In scanning microscopy, a specimen is illuminated with a light beam in order to observe the reflected or fluorescent light emitted from the specimen. The focus of an illuminating light beam is moved in a specimen plane by means of a controllable beam deflection device, generally by tilting two mirrors, the deflection axes usually being perpendicular to one another so that one mirror deflects in the X direction and the other in the Y direction. Tilting of the mirrors is brought about, for example, by means of galvanometer positioning elements. The power level of the light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam.

A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back through the beam deflection device to the beam splitter, passes through it, and is then focused onto the detection pinhole behind which the detectors are located. Detection light that does not derive directly from the focus region takes a different light path and does not pass through the detection pinhole, so that a point datum is obtained which results, by sequential scanning of the specimen, in a three-dimensional image. A three-dimensional image is usually achieved by acquiring image data in layers, the track of the scanning light beam on or in the specimen ideally describing a meander (scanning one line in the X direction at a constant Y position, then stopping the X scan and slewing by Y displacement to the next line to be scanned, then scanning that line in the negative X direction at constant Y position, etc.). To allow the acquisition of image data in layers, the specimen stage or the objective is shifted after a layer has been scanned, and the next layer to be scanned is thus brought into the focal plane of the objective.

In many applications, specimens are prepared using a plurality of markers, for example several different fluorescent dyes. These dyes can be excited sequentially, for example with illuminating light beams that have different excitation wavelengths. Simultaneous excitation using an illuminating light beam that contains light of several excitation wavelengths is also common. European Patent Application EP 0 495 930 “Confocal microscope system for multi-color fluorescence,” for example, discloses an arrangement having a single laser emitting several laser lines. In practical use at present, such lasers are most often embodied as mixed-gas lasers, in particular as ArKr lasers.

Spectral detectors that, for example, can be embodied as multiband detectors, as disclosed e.g. by German Unexamined Application DE 198 03 151.3 A1, are used for detection in this context.

German Unexamined Application DE 198 29 944 A1 discloses a method and an arrangement for device configuration of confocal microscopes in which laser light having one or more spectral lines is generated and is directed onto a specimen which contains a fluorescent dye or onto which a fluorescent dye is applied. The excitation wavelengths and emission wavelengths of various fluorescent dyes are acquired in separate data sets, and those sets are stored in a data memory. The laser spectra that can be set using the microscope and are to be directed onto the specimen, and the transmission spectra achievable with the available filters, are similarly acquired in data sets and those data sets are stored. From a computational combination of these data sets, parameters for configuring the microscope are determined.

At present, the spectral data measured by the spectral detector are transferred via a data bus to the modules or computers or PCs performing further processing. This is possible online if the number of scan points scanned simultaneously is small. At present, the maximum bandwidth of the data bus is, typically exhausted at 10 MB per transfer channel per second. If the spectral data are very voluminous and if many scan points are being scanned simultaneously, as is usual e.g. in the case of line scanners or Nipkov systems, the bandwidth is then no longer sufficient for online transfer, so that online depiction of the specimen is not possible without losing information.

### SUMMARY OF THE INVENTION

It is therefore the object of the invention to propose a method for scanning microscope that makes possible online observation of a specimen, reliably and with minimum information loss, even when large quantities of spectral data are being generated simultaneously.

The object is achieved by way of a method comprising the steps of:

illuminating a specimen that contains at least one fluorescent dye, using illuminating light;

detecting the detection light proceeding from scan points of the specimen, using a spectral detector that generates spectral data for each scan point;

determining from the spectral data an amplitude value for each fluorescent dye; and

transferring the amplitude values to a processing module.

It is a further object of the invention to describe a scanning microscope with which online observation of a specimen is reliably possible even when large quantities of spectral data are being generated simultaneously.

This object is achieved by way of a scanning microscope comprising: a light source that emits illuminating light for illumination of a specimen that contains at least one fluorescent dye, a scanning device for scanning scan points of the specimen, a spectral detector for detecting the detection light proceeding from the scan points, the spectral detector generating spectral data for each scan point, a module for determining, from the spectral data, an amplitude value for each fluorescent dye; and means for transferring the amplitude values to a processing module.

The invention has the advantage that the “bottleneck” of the fundamentally limited transfer rate from the scanning head of a scanning microscope to the processing module, which generates from the incoming detected signals and spectral data image data that can be displayed to the user, and which is usually embodied as a PC physically separated from the scanning head, is no longer the limiting factor in terms of online observation of a specimen even if, for example, entire scan lines having many, e.g. 1024, scan points are being scanned simultaneously.

According to the present invention, this is achieved by the fact that as early in the data chain as possible, a data reduction is achieved which, however, is not associated with a loss of information. In a preferred embodiment, the data reduction, namely the determination from the spectral data of an amplitude value for each fluorescent dye, is already completed in a module within the electronics of the scanning head. This module is preferably implemented in the form of a programmable electronic system, for example a field programmable gate array (FPGA) or digital signal processor (DSP).

In a preferred embodiment, the spectral detector encompasses a grating spectrometer or prism spectrometer, or preferably a multiband detector.

In a preferred embodiment, the illuminating step encompasses a scanning of the scan points of the specimen with illuminating light, in particular with the focus of an illuminating light beam. The latter can, for example, be guided in meander fashion over or through the specimen. It is also possible to illuminate the specimen in large-area fashion (not by scanning), and to perform the allocation of spectral data to scan points by means of scanning detection, which can be achieved particularly effectively using confocal arrangements.

In a preferred embodiment, the scanning occurs sequentially. In another variant, the scanning is accomplished at least partially simultaneously or line-by-line.

A preferred variant embodiment of the method encompasses the further step of determining from the spectral data the at least one fluorescent dye contained in the specimen. In a preferred embodiment, this can encompass a comparison of the spectral data to reference data stored in a memory module for various fluorescent dyes. The reference data are prepared on the basis of the known emission spectra of the fluorescent dyes, and stored in the memory module. The reference data can, for example, be stored in the memory module upon manufacture or, depending on the application, individually loaded into the memory module by the user or automatically. If no reference data are available for the emission spectrum of a (for example, exotic) fluorescent dye, those data can be determined during the measurement and can be added to the reference data for future investigations, so that at the next occurrence of comparable spectral data for a pixel, all that is necessary is to access the reference data. The comparison of the spectral data to the reference data preferably encompasses a minimization of the sums of the error squares.

In a preferred variant, the method encompasses, after transfer, the further step of reconstructing the spectral data in the processing module from the transferred amplitude values. This is possible using simple computation operations, since the type of data reduction on the basis of the reference data, and the reference data themselves, are known to the processing module.

In a particularly preferred embodiment, the deviation of the measured spectral data from the corresponding reference signal is also transferred to the processing module as additional information from which conformity can be evaluated. The additional information can contain, for example, the sum of the error squares.

The method is advantageous both in multi-point scanners and line scanners, and also in very fast single-point scanners, especially for continuous scans; and also in the context of transfer via data networks, for example the Internet.

In a very particularly preferred embodiment, the scanning microscope is a confocal scanning microscope.

### BRIEF DESCRIPTION OF THE DRAWINGS

The subject matter of the invention is depicted schematically in the drawings and will be described below with reference to the Figures, identically functioning elements being labeled with the same reference characters. In the drawings:

FIG. 1 shows a scanning microscope according to the present invention; and

FIG. 2 is a flow chart for the method according to the present invention.

### DETAILED DESCRIPTION OF THE INVENTION

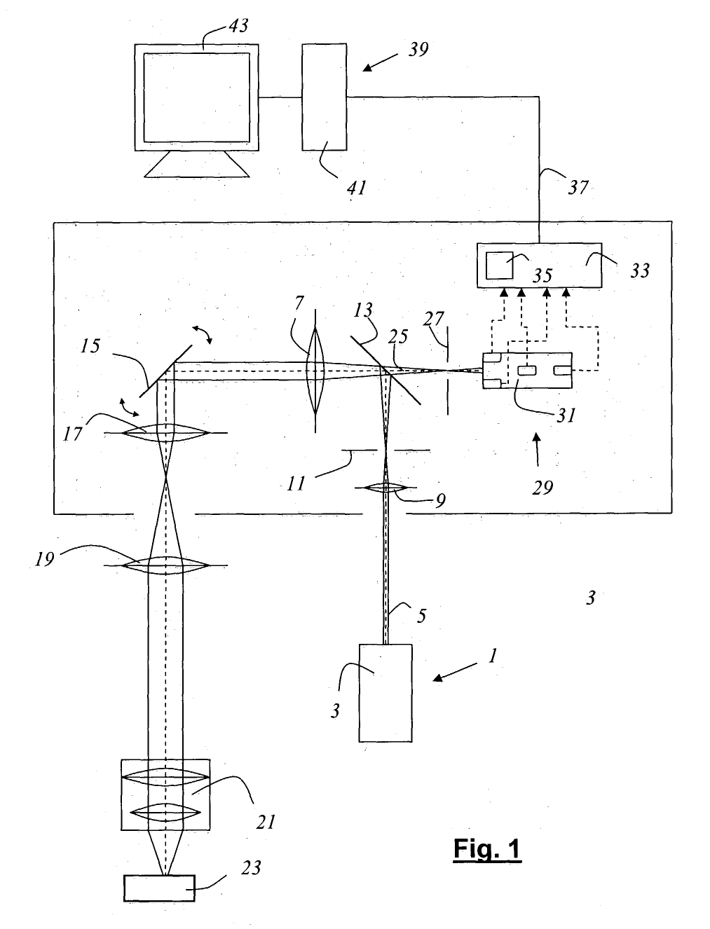

FIG. 1 schematically shows a scanning microscope according to the present invention that is embodied as a confocal scanning microscope. Light beam 5 coming from a light source 1, which is embodied as a multiple-line laser 3, is focused by means of optical system 9 onto illumination pinhole 11. After passing through illumination pinhole 11, illuminating light beam 5 is deflected by a beam splitter 13 through lens element 7 to a gimbal-mounted scanning mirror 15 that guides illuminating light beam 5 through scanning optical system 17, tube optical system 19, and objective 21, over or through specimen 23. The specimen is labeled with several fluorescent dyes. In the case of non-transparent specimens 23, illuminating light beam 5 is guided over the specimen surface. With biological specimens 23 (preparations) or transparent specimens, illuminating light beam 5 can also be guided through specimen 23. Detection light beam 25 proceeding from specimen 23 travels through objective 21, tube optical system 19, and scanning optical system 17 and via scanning mirror 15 to beam splitter 13, passes through the latter, and after passing through detection pinhole 27 strikes a spectral detector 29, which is embodied as a multiband detector 31 and which generates electrical detected signals, in the form of spectral data, and forwards them to a module 33 for determining an amplitude value. In module 33, which is embodied as a FPGA module, an automatic determination is made, from the spectral data, of the fluorescent dyes contained in the specimen, by comparing the spectral data to reference data stored in a memory module 35 for various fluorescent dyes. A determination is then made of an amplitude value with reference to each identified fluorescent dye, based on the spectral data. The amplitude values, together with data concerning the identified fluorescent dyes, are transferred by means of a data bus 37 to a processing module 39 that is embodied as a PC 41. After transfer, the spectral data are reconstructed in processing module 39 from the transmitted amplitude values and the data concerning the identified fluorescent dyes. The graphically processed results are displayed to the user on a monitor 43.

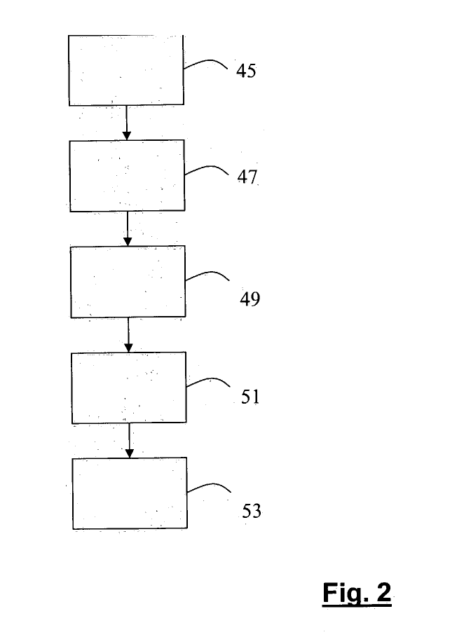

FIG. 2 shows, in a flow chart, the sequence of a method according to the present invention. In a first step, scanning 45 of scan points of a specimen with illuminating light is performed; in a further step, detection 47 of the detection light proceeding from the scan points is performed, using a spectral detector that generates spectral data for each scan point. The spectral detector can be embodied, for example, as a prism detector, grating detector, or multiband detector. In a third step a determination 49 is made, from the spectral data, of an amplitude, for each fluorescent dye contained in the specimen, that is proportional to the proportion (as a function of the total detection light) of the light in a pixel proceeding from that fluorescent dye; the amplitude values are then transferred 51 to a processing module. In a final step, reconstruction 53 of the spectral data from the transmitted amplitude values is performed, in a processing module.

The invention has been described with reference to a particular exemplary embodiment. It is self-evident, however, that changes and modifications can be made without thereby leaving the range of protection of the claims below.

What is claimed is:

1. A method for scanning microscopy comprising the steps of:
illuminating a specimen that contains at least one fluorescent dye, using illuminating light;
detecting the detection light proceeding from scan points of the specimen, using a spectral detector that generates spectral data for each scan point;
determining from the spectral data an amplitude value for each fluorescent dye; and
transferring the amplitude values to a processing module.

2. The method as defined in claim 1, wherein the step of illuminating encompasses scanning of the scan points of the specimen with illuminating light.

3. The method as defined in claim 1, wherein the scanning is accomplished sequentially.

4. The method as defined in claim 1, wherein the scanning is accomplished at least partially simultaneously.

5. The method as defined in claim 4, wherein the scanning is accomplished line-by-line.

6. The method as defined in claim 1, wherein the spectral detector encompasses a grating spectrometer or prism spectrometer.

7. The method as defined in claim 1, wherein the spectral detector encompasses a multiband detector.

8. The method as defined in claim 1 comprising the further step of: determining from the spectral data the at least one fluorescent dye contained in the specimen.

9. The method as defined in claim 8, wherein the determination of the at least one fluorescent dye contained in the specimen encompasses a comparison of the spectral data to reference data stored in a memory module for various fluorescent dyes.

10. The method as defined in claim 1 comprising the further step of:
reconstructing the spectral data in the processing module from the transferred amplitude values.

11. A scanning microscope comprising:
a light source that emits illuminating light for illumination of a specimen that contains at least one fluorescent dye, a scanning device for scanning scan points of the specimen, a spectral detector for detecting the detection light proceeding from the scan points, the spectral detector generating spectral data for each scan point, a module for determining, from the spectral data, an amplitude value for each fluorescent dye; and means for transferring the amplitude values to a processing module.

12. The scanning microscope as defined in claim 11, wherein the scanning is accomplished sequentially.

13. The scanning microscope as defined in claim 11, wherein the scanning is accomplished at least partially simultaneously.

14. The scanning microscope as defined in claim 11, wherein the scanning is accomplished line-by-line.

15. The scanning microscope as defined in claim 11, wherein the spectral detector encompasses a grating spectrometer or prism spectrometer.

16. The scanning microscope as defined in claim 11, wherein the spectral detector encompasses a multiband detector.

17. The scanning microscope as defined in claim 11, wherein the at least one fluorescent dye contained in the specimen can be determined from the spectral data.

18. The scanning microscope as defined in claim 17, wherein a memory module is provided, and the determination of the at least one fluorescent dye contained in the specimen encompasses a comparison of the spectral data to reference data that can be stored in a memory module for various fluorescent dyes.

19. The scanning microscope as defined in claim 11, wherein the spectral data can be reconstructed in the processing module from the transferred amplitude values.
